(19) United States
(12) Patent Application Publication
(10) Pub. No.: US 2005/0227705 A1
(43) Pub. Date: Oct. 13, 2005

(54) Data communication method, telecommunication system and mobile device

(76) Inventors: Seppo Rousu, Oulu (FI); Marko Leinonen, Oulu (FI)

Correspondence Address: CRAWFORD MAUNU PLLC, 1270 NORTHLAND DRIVE, SUITE 390, ST. PAUL, MN, 55120, US

(21) Appl. No.: 10/820,893

(22) Filed: Apr. 8, 2004

(51) Int. Cl. H04Q 7/20

(52) U.S. Cl. 455/456.1; 455/456.6

(57) ABSTRACT

A data communication method in a communication system is provided. Speech and/or data is transmitted and received by a mobile device of the communication system using a predetermined transmission resource. The location of the mobile device of the communication system is determined. Information about the location of the mobile device is transmitted, with the speech or data, to a predetermined group of users by using the predetermined transmission resource.

### FIELD

The invention relates to a data communication method in a communication system comprising mobile devices. Especially the invention relates to determining the location of mobile devices and to the transmission of the location data of the devices.

### BACKGROUND

In the past, telecommunication systems comprising mobile devices have offered conventional speech service as the only service. In recent years other services have also gained popularity. One such service is determining the location of a mobile device. The geographical location of the mobile device may be determined and this information may be offered to the user in various forms and in addition several location dependent services may be offered.

There are various ways to determine the geographical location of a mobile device. The methods differ in accuracy. The location of a mobile device may be determined using signals transmitted between the mobile device and the surrounding base stations. The required measurements and processing may be performed either in the mobile device or in the base stations. Another known method is to utilize a satellite location system.

Information about the location of mobile devices has so far been transmitted in specific messages, for example with the aid of short message service (SMS), i.e a mobile device informs to a base station or a third party receiver its location in a short message. One problem relating to the use of SMS is that information sharing does not happen in real time and that the use of SMS requires the use of separate resources specifically allocated for the purpose. These problems are specifically present when the mobile device is participating in a group call and there is a need to transmit location information between the participants.

A group call is a service where a call is established between several participants. Each participant in the group call is able to monitor the transmissions of all the other participants and to produce its own transmission that can be received by all the other participants.

A group call may be realized for example as a push-to-talk-service. In such a service, the participants of the group call have a packet connection, such as a GPRS connection, open all the time. The devices may thus receive the transmissions of other participants continuously. However, resources for transmission are reserved only when the user presses a predetermined button and starts to speak. Thus, the use of transmission resources is efficient.

### BRIEF DESCRIPTION OF THE INVENTION

An object of the invention is to provide an improved solution to transfer location related information in a telecommunication system. According to an embodiment of the invention, there is provided a data communication method in a communication system, comprising: transmitting and receiving speech and/or data by means of a mobile device of the communication system and by using a predetermined transmission resource, determining the location of the mobile device of the communication system, transmitting, with the speech or data, information about the location of the mobile device to a predetermined group of users by using the predetermined transmission resource.

According to another embodiment of the invention, there is provided a mobile device, comprising: determining means to determine the location of the mobile device, and transmitting means connected to the determining means to transmit speech and/or data by using a predetermined transmission resource and to transmit information about the location of the mobile device by using the same predetermined transmission resource.

According to another embodiment of the invention, there is provided a telecommunication system, comprising mobile devices and at least one network element, the system comprising: means to determine the location of a mobile device, transmitting means in the mobile device to transmit speech and/or data to the network element by using a predetermined transmission resource, and to transmit information about the location of the mobile device by using the same predetermined transmission resources.

The proposed solution provides several advantages. The solution does not use separate resources for the transmission of location related information. Thus, valuable resources are saved. In an embodiment of the invention where packet transmission is used, the transmission of location related information does not increase connection related costs because user billing is based on the transmitted amount of data. The amount of data needed in location information transmission is low. Since separate resources are not reserved, the amount of data is kept as low as possible. This applies especially to group calls; a separate SMS to each participant would be much more expensive than the proposed solution.

An embodiment of the invention enables real time transmission of location information. As the location related information is sent in connection with speech no time is spent on allocating separate resources. The transmission of location related information does not decrease the quality of speech transmission, as the amount of transmitted data is low.

### LIST OF DRAWINGS

In the following, the invention will be described in greater detail with reference to the preferred embodiments and the accompanying drawings, in which

FIGS. 1A and 1B illustrate examples of a data transmission system;

FIGS. 2A to 2D illustrate embodiments of the inventions;

FIG. 3 illustrates an example of the structure of a mobile device; and

FIG. 4 illustrates an example of packet transmission.

### DESCRIPTION OF EMBODIMENTS

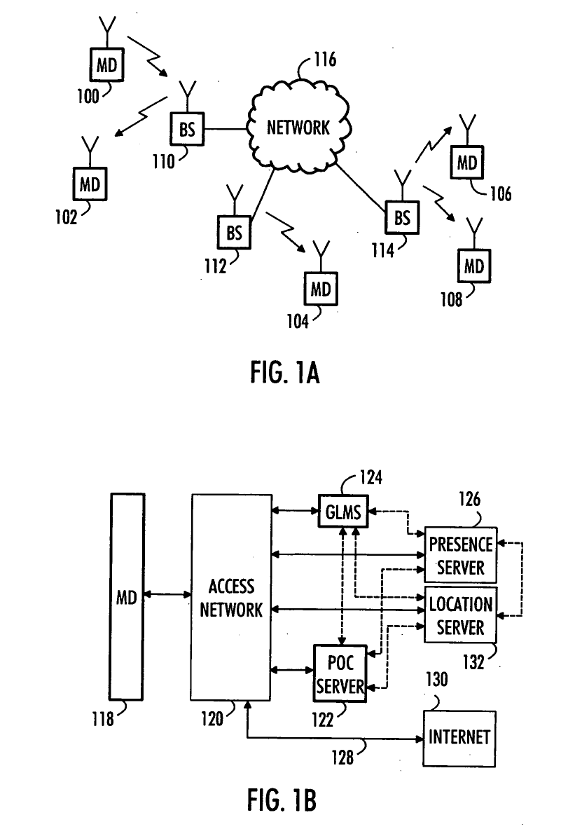

With reference to FIG. 1A, examine an example of a data transmission system in which some embodiments of the invention can be applied. The embodiments are described using a system employing a Push-to-Talk over Cellular (PoC) service. However, the invention is not restricted to such examples, as is evident to one skilled in the art. The invention may be applied in any telecommunication system where speech or data or both is transmitted using predetermined resources and where the location of a mobile device can be determined. Embodiments of the invention may also be implemented in a call between two participants and not only in a group call as illustrated in FIG. 1A. The devices receiving location related data from a mobile device may be mobile devices, fixed terminals, or personal computers provided with suitable communication equipment.

FIG. 1A shows mobile devices 100 to 108 participating in a group call realized using a PoC service. The devices are connected to base stations 110 to 114 which in turn are connected to a network 116. The mobile devices 100 and 102 are connected to the base station 110, the mobile device 104 is connected to the base station 112, and the mobile devices 106 and 108 are connected to the base station 112.

In the example of FIG. 1A, each mobile device 100 to 108 has a packet data connection open to the base station it is connected to. The connection between a base station and a mobile device may be realized using UTRA (Universal Terrestrial Radio Access) of UMTS (Universal Mobile Telecommunication System) or a GPRS (General Packet Radio Service) based radio access network or other similar services offering arrangement. In a typical packet data connection, transmission resources are used only when there is something to transmit. Thus, although the connection is logically open all the time, a mobile device transmits nothing if the user is not speaking. In a group call realized using a PoC service, each mobile transmits only if the user presses a predetermined button and starts to speak. In the example of FIG. 1A, the mobile device 100 is transmitting to the base station 110. The transmission of the device 100 is sent to all participants of the group call.

FIG. 1B illustrates an example of the structure of the data transmission system from a group call and PoC point of view. A mobile device 118 of the data communications system is connected to the system via an access network 120. The access network may be realized using the above mentioned UTRA or a GPRS (General Packet Radio Service) based network or other similar services offering arrangement. The mobile device supports group calls and PoC by providing appropriate software. The mobile may comprise a predetermined button with which the user may indicate to the system his/her willingness to talk. The mobile device further supports packet data connections.

The system may further comprise a network element 122 operationally connected to the access network 120 and acting as a PoC server. The network element 122 provides PoC session handling. The network element receives from the mobile device information indicating that the user has pressed the predetermined button. The network element provides a floor control functionality in the group call. It thus allocates turns to speak in the group call and is responsible for distributing the signals between the participants.

The system may further comprise a network element 124 operationally connected to the access network 120 and acting as a Group Management Server. The network element 124 provides group management in group calls. It provides the information relating to creating, updating and deleting groups and the participants of the groups.

The system may provide a connection 128 to the Internet 130 so that devices such as computers connected to the Internet may be accessed by the network elements or by a mobile device 118 connected to the system.

In an embodiment, the system may further comprise a network element 126 operationally connected to the access network 120 and acting as a presence server. This is an additional service recently created in cellular systems. Presence information refers to a kind of dynamic profile, which the user publishes and which is available to the users that have subscribed to the service. The information may comprise, for instance, data about the availability of the user and about the type of data transmission supported by the user's mobile device. The data concerning all the users utilizing the service is typically maintained in the network server 126 of the system, and from there user profiles requested by users can be transferred to the device of each subscriber. The presence server may contain the location information of the user. The location information may also be stored in another network element 132, called a location server operationally connected to the access network 120. The presence server may receive the location information from the location server. Other users can request this location information. When normal presence information, e.g. current user profile, is transmitted also the actual physical location can be transmitted.

The network server 132 can gather location information of several users. When user location information is updated to the server, a time stamp of location information can be added to the location info. This way updated information can be sent to users when the constant user location update service is activated. If a user requests the locations of other users, the server can reply immediately the last updated locations. This way a fast response time of the last updated locations can be made.

In an embodiment of the invention, the location of a mobile device of the communication system is determined. There are various ways to determine the geographical location of a mobile device. It may be determined using signals received by base stations around the mobile device. One solution is based on the times of arrival of the signals (TOA, Time of Arrival; TDOA, Time Difference of Arrival). In this method an additional receiver is placed at the base station. The above method requires that each base station is able to accurately determine the time of the access message by applying one and the same time reference.

Another known method is based on the Observed Time Difference (OTD) between the signals. In this method the mobile device measures a timing difference between the base stations. The method also requires information about the difference in synchronization between the base stations (RTD, Real Time Difference), in case the base stations are not synchronized. The location is determined on the basis of this information.

Yet another known method is to utilize satellite location system, such as GPS (Global Positioning System), GLONASS (GLObal NAvigation Satellite System) or Galileo. In this solution, the mobile device comprises a satellite receiver that receives location signals sent by location satellites and calculates the location of the device on the basis of the signals. This method is quite accurate, but it usually works only outdoors.

Another method is to utilize inertia navigation arrangement. In this method the mobile device comprises a sensor system detecting its movement. The mobile may measure its movements using a given location as a starting point, for example. The sensor system may comprise acceleration sensors and a compass, for example.

One possible method to get location information is to receive the information from another device. As an example, a mobile terminal may be connected via a Bluetooth connection to a GPS device or to another mobile device.

The location information may comprise latitude and longitude coordinates and altitude information. The location information may also comprise information about how the location was determined and the time of the determination or the time of sending of the information.

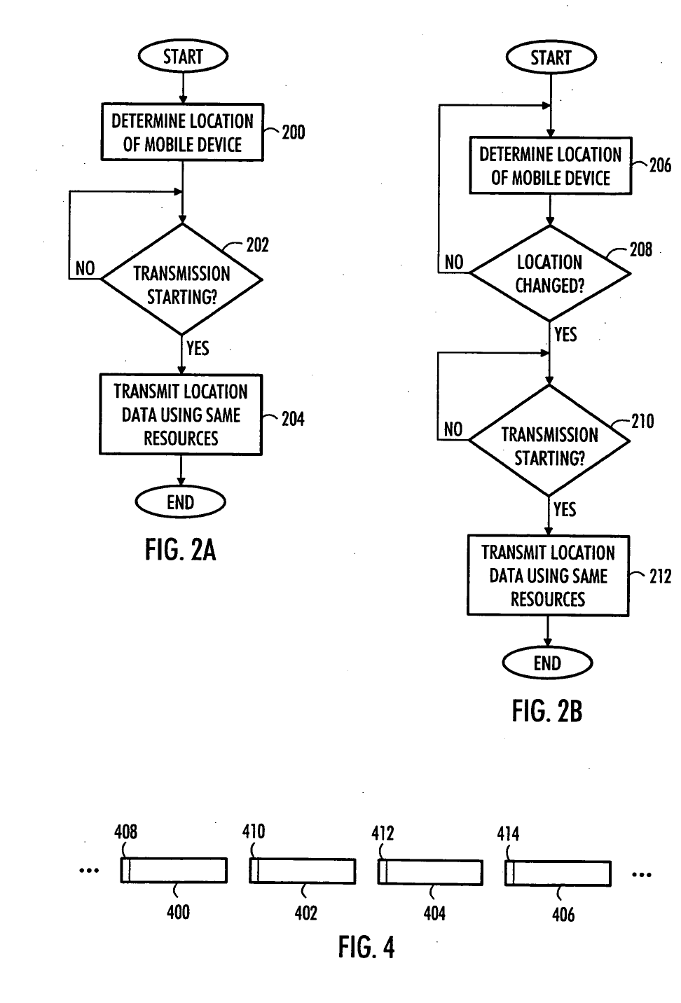

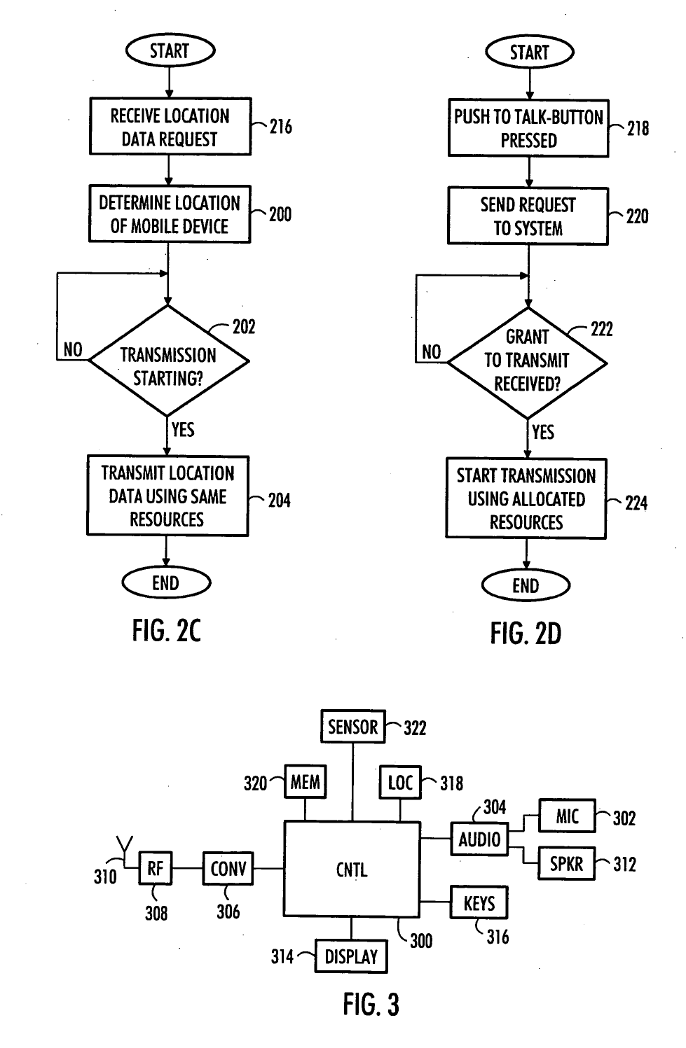

The flowchart of FIG. 2A illustrates an embodiment of the invention. In step 200 the location of a mobile device is determined using known techniques. In step 202 it is checked whether the mobile device is starting to transmit or is transmitting speech using predetermined transmission resources. If this is not the case, the algorithm waits until speech transmission starts. If speech is being transmitted, location related information is transmitted in step 204 using the same transmission resources as in the speech transmission.

In the above example the mobile device transmitted speech. In an embodiment, the location related information is transmitted in connection with a data transmission in a similar manner as described above.

The flowchart of FIG. 2B illustrates another embodiment of the invention. In step 206 the location of a mobile device is determined using known techniques. In step 208 the determined location of the mobile device is compared to a previous known location of the mobile device. This known location may be stored in memory. If the location is the same, then no action is taken. The comparison may use a threshold value, so that small changes in location are not taken into account. If the location of the device changes, it is checked in step 210 whether the mobile device is starting to transmit data or is transmitting speech by using predetermined transmission resources. If this is not the case, the algorithm waits until transmission starts. If speech or data is being transmitted, location related information is transmitted in step 212 using the same transmission resources as in the speech or data transmission.

The flowchart of FIG. 2C illustrates another embodiment of the invention. In step 216 a request concerning the location data of a mobile device is received. The request may be received by the mobile device and it may originate from a participant of an ongoing group call or from the system. It may also come from the user of the mobile device who wants to know the location and possibly convey the information to others. In the latter case the user may use the user interface of the mobile device to request the mobile device to determine its location. The following steps are then the same in this example as in the flowchart of FIG. 2A.

In an embodiment of the invention, location related information is transmitted periodically. The transmission is performed every 5 minutes, for example.

The flowchart of FIG. 2D illustrates an embodiment of a PoC feature. In this embodiment the mobile device comprises a keyboard with a predetermined key with which the user may indicate a willingness to speak in an ongoing group call. In step 218 the mobile device detects that the predetermined push-to-talk key has been pressed. In step 220 the mobile device sends the system a request to start speech transmission. In the system, a network element acting as a PoC server receives and processes the request. The mobile device waits for the response in step 222. When the mobile device receives a positive response and information about resources allocated to it, it starts transmission using the allocated resources in step 224.

In an embodiment, a packet switched connection is utilized in the communication between the mobile device and the communication system. In this embodiment information is transmitted between the mobile device and the system in packets. In an embodiment, the packets are similar to IP (Internet Protocol) packets used in the Internet.

In an embodiment, location data of the mobile users is stored in a network server. The server can be addressed or requested from the Internet by a processing device, such as a laptop computer, personal computer or any other device provided with an Internet-enabled processor. The connection may be encrypted for security reasons. The server may require authentication from the devices trying to request information from the server. The amount of information that a device may request from the server may be limited by using a suitable license or authentication method. For example, the server may maintain list of devices which may access given data from the server.

As an example, a delivery company office can monitor the location of the delivery cars. The location data is requested by a personal computer via the Internet from a network element where location information is stored.

In an embodiment, when the mobile device starts a speech transmission using given packet switched resources and there exists location related information to be sent, the mobile device sends the location related information in the first packets of the transmission before speech packets or in another predefined part of the transmission. As the amount of data in the location related information is small, the information will not take many packets and the delay in the speech transmission is negligible. In an embodiment, the location data packets replace some speech packets in the transmission. Again, as the number of packets to be replaced is small, the resulting decrease in the quality of the transmitted speech is negligible.

The transmitted speech packets comprise a flag indicating that the packet comprises speech data. The receiving end will notice the flag and process the packet accordingly. For example, if the receiving end is a mobile telephone, it will direct the incoming speech packets to a speech decoder. In a similar manner, the location data packets may comprise a flag indicating that the packet comprises location related information.

In an embodiment, the location related information is sent as a separate message which is transmitted using the same predetermined transmission resources as speech or data. The message could be sent to a group of users or to a user.

In an embodiment, a Session Initiation Protocol (SIP) is utilized in the communication between the mobile device and a network server. The SIP is a transaction protocol that can be used to implement different types of services. SIP messages are used for example to initiate and manage calls. In the SIP, each transaction consists of a request sent by a client. The request invokes a given method or function on a server and at least one response to the client. For example, a call set up message uses an INVITE SIP method, and a simplified example of a general call set up message may be of the form
INVITE sip:johndoe@srvr.com SIP/2.0
Via SIP/2.0/UDP pc33.chigaco.com;branch=z9hG4bK776asdhds
P-Preferred-Identity: Jack <sip:jackdoe@srvr.com>
From: Jack <sip:jackdoe@srvr.com>;tag=1928301774
To: John <sip:johndoe@srvr.com>
Call-ID: a84b4c76e66710@pc33.chigaco.com
CSeg: 314159 INVITE
Contact: <sip:jackdoe@pc33.chigaco.com>

The first line of the message contains the name of the method (INVITE) and a so-called Request-URI, which correspond to the recipient of the message (in this example johndoe@srvr.com). The underlined sections are header fields of the message. The To-field defines the address (URI) of the recipient of the message, but is not necessarily a valid URI, as this might be used, for example, in gaming applications such as “Alien.Blaster@star.wars”. Therefore this address does not necessarily correspond to the Request-URI field. The sender or originator of the message is contained in the From-field, the same restrictions as mentioned for the To header apply here as well. The P-Preferred-Identity holds a valid URI of the sender of the message for the creation of an asserted identity within the IMS in order to indicate that the user sending this message is showing a valid identity. The Call-ID defines a globally unique identifier for the call. The combination of the To-tag, From-tag and Call-ID fields define a peer-to-peer SIP relationship between participants and is called a dialog. The definitions of the other fields are well known to one skilled in the art and they are not discussed in detail in this case. The message may also contain other fields not shown in the example above for simplicity.

The participants of a connection may use SIP messages to manage the call and to transfer information. In an embodiment of the invention, information about the location of the mobile device is included in a Content-Length-field of a SIP message. The information may be in ASCII-format. For efficient SIP protocol usage, the location information may need a separate dedicated information data field in a message. When new terminals are introduced old terminals that do not support all SIP message fields ignore the extra information.

In an embodiment of the invention, the devices which are the recipients of the location related information sent by a mobile device send an acknowledgement to the mobile device either automatically or in response to a command given by the user of the device. A user can see from his/her own terminal information about which users have got latest location information or which users have confirmed the updates of the locations.

In an embodiment of the invention, the mobile device may have different user selectable privacy levels. The selected privacy level may control the transmission of location related information in such a way that when a high privacy level is in use the location related information is sent only to those users who fulfill a given criteria and when a low privacy level is selected there are no restrictions regarding the recipients of the location related data. The privacy level may be the same as the one used and maintained in the presence server.

It is also possible to have several privacy levels: one for connections with users of the same group and one for connections between groups. The location information may be shared within one group but not with another group, if the other group has a lower privacy level than the first group.

The privacy level of the location data can define how location information is to be used e.g. in advertising, government usage. A user can adjust the usage of the location information for such purposes.

The information about the location of the mobile device may be sent without user intervention. Correspondingly, the receiving device may be configured to utilize the location related data without user control. The information about the location of the mobile device may be used as input information for an application running in a mobile device or a computer without intervention by the user of the device or computer. For example, the device may display locations of devices graphically on a map.

Location information can be delivered from person to person, from one person to multiple persons, from multiple persons to one person, or from multiple persons to multiple persons. In an embodiment, the location information can be routed from one predefined user group to another predefined user group. The routing from one user group to another requires checking the privacy levels of all users. If some of the users deny the sharing of the location info within another group, no info of the group is shared.

In an embodiment, the user may ask for the locations of other mobile users by sending an enquiry to the network server responsible for location services. The server copies the actual request to other users of the user group as in a PoC speech call. The server may also reply immediately by providing the latest user locations or the locations updated within a given time limit, for example one hour. The time limit may be defined in the request. When the other users have replied to the location update request, the new updated locations are sent to the original questioner. In an embodiment, a user can ask which other users are within a predefined geographical area. The geographical area of interest can be defined in the location request. The geographical area definition can be done via terminal display, menu query, postal number, street address, for example.

With reference to FIG. 3, an example of the structure of a mobile device will be examined next. The mobile device comprises a control unit 300, which controls the operation of the entire apparatus. The control unit is typically a processor including software, but it can also be implemented using separate components. The mobile device further comprises a microphone 302 which converts user's speech into electrical form. The user's speech is conveyed from the microphone to audio parts 304, where the speech is converted into digital mode and speech coded in a speech coder.

The mobile device further comprises transmitting means for transmitting the coded speech by using given resources. The control unit 300 conveys the coded speech via a converter 306 to radio frequency unit 308 and antenna 310 which provide a radio connection to the network. The converter 306 converts signals between the analog mode used in the radio frequency unit 308 and the digital mode used in the other parts of the device.

When receiving speech, the control unit conveys the received signal to audio parts 304, where the required decoding and the conversion into analogue mode are carried out, the signal being then conveyed into a speaker or an earphone 312. The device also comprises a display 314 and a keyboard 316. The display 314 and keyboard 316 are operationally connected to the control unit.

In an embodiment the mobile device comprises a WLAN (Wireless Local area Network) transceiver or a short-range radio transceiver, such as a Bluetooth transceiver, instead or in addition to the radio frequency unit 308.

In an embodiment, the device comprises location determining means 318. The means may be implemented by a satellite location system receiver, such as a GPS receiver. The means may also be implemented using a processor which calculates the location of the device by using one of the methods described earlier or a corresponding similar method known to one skilled in the art. The control unit 300 may send the location determination unit 318 a message to determine the location of the device and the unit responds with a message containing information regarding the location.

In an embodiment, the location determining means 318 comprise a sensor system detecting the movement of the mobile device. The mobile may measure the movements of the device using a given location stored in the control unit of the device, for example, as a starting point. The sensor system may comprise acceleration sensors and a compass, for example.

In an embodiment, the device comprises a memory 320 which may be used to store information about the location of the device. With this information, the control unit may determine whether the location of the device has changed.

In an embodiment, the keyboard 316 of the mobile device comprises a predetermined push-to-talk key. When the control unit 300 detects that the user of the device has pressed the push-to-talk key, it starts speech transmission according to the procedure described flowchart of FIG. 2D, for example. The control unit may be configured to transmit information about the location of the mobile device in the beginning of the transmission before speech or data.

In an embodiment, the control unit of the mobile device is configured to establish a packet switched connection between the mobile device and a network element of a communication system as a predetermined transmission resource.

In an embodiment of the invention, the determination and transmission of location related information is be triggered by an external event detected by a sensor 322 of the mobile device. The sensor may be monitoring temperature in the surroundings of the device. The sensor may be measuring some health related property of the user of the device. The health related property may be temperature, blood pressure, heart rate or blood sugar, for example. In an embodiment, the control unit 300 of the device receives measurement results from the sensor 322 and compares the results with a given threshold. If the threshold is exceeded the control unit is configured to determine the location of the mobile device and send the information to a predetermined group of users.

In an embodiment of the invention, the determination and transmission of location related information is triggered by a voice command or sound. The mobile device may monitor sound volume detected by the microphone 302 and when the volume exceeds a given threshold, location information is sent. This enables the use of location information in solutions where mobile devices are mounted in unmanned vehicles or carried by animals, such as dogs, for example.

The mobile device may further comprise other elements, but these are not described here for the sake of clarity.

In an embodiment of the invention, a user may have several IP sessions or several terminals connected to a network. The locations of all devices are updated to the network. The user may control the amount of location information visible to other users. For example, if multiple terminals are connected to the network and one of the terminals moves more than a predefined distance, only the location data of the moved terminal is visible to other users.

With reference to FIG. 4, an example of packet transmission is studied. FIG. 4 illustrates a group of packets 400 to 406 transmitted by a mobile device when the user of the device has pressed a push-to-talk button and the device has been granted transmission resources from the system. In addition to speech, the mobile device also transmits information about the location of the device. Each packet 400 to 406 comprises a flag 408 to 414, respectively, to indicate the type of the packet. In FIG. 4, the flags are at the beginning of each packet. In practise, the flags may be in any part of the packet. The flags may be realized with a predetermined bit or a bit sequence.

Let us assume that location data is transmitted in packet 400. Thus, flag 408 indicates to the receiving end that the packet comprises location data. Flags 410 to 414 of the other packets indicate that the packets comprise speech and thus should be therefore directed to a speech decoder.

In an embodiment, the solution is implemented as a computer program product encoding a computer program of instructions for executing a computer process for data communication in a mobile device. In an embodiment, the solution is implemented as a computer program distribution medium readable by a computer and encoding a computer program of instructions for executing a computer process for data communication in a mobile device. The type of distribution medium may be one of the following: a computer readable medium, a program storage medium, a record medium, a computer readable memory, a computer readable software distribution package, a computer readable signal, a computer readable telecommunications signal, a computer readable compressed software package.

The program may be downloaded into the mobile device from a distribution medium readable by the device. The program may be downloaded from a network, for example. The program may be stored in the memory 320.

Even though the invention is described above with reference to an example according to the accompanying drawings, it is clear that the invention is not restricted thereto but it can be modified in several ways within the scope of the appended claims.

1. A data communication method in a communication system, comprising:
transmitting and receiving speech and/or data by means of a mobile device of the communication system and by using a predetermined transmission resource,
determining the location of the mobile device of the communication system,
transmitting, with the speech or data, information about the location of the mobile device to a predetermined group of users by using the predetermined transmission resource.

2. The method of claim 1, wherein the determining step further comprises: determining the location in the mobile device.

3. The method of claim 1, wherein the determining step further comprises: determining the location using a satellite positioning system.

4. The method of claim 1, further comprising: establishing a packet switched connection between the mobile device and a network element of the communication system as the predetermined transmission resource.

5. The method of claim 1, further comprising: transmitting information about the location in response to a command given by the user of the device.

6. The method of claim 1, further comprising:
detecting a change in the location of the mobile device;
transmitting information about the location on the basis of the detection.

7. The method of claim 1, wherein the mobile device is participating a group call.

8. The method of claim 7, wherein the predetermined group of users is participating in a group call.

9. The method of claim 1, wherein at least one user of the predetermined group of users receives the information about the location using a mobile device.

10. The method of claim 1, wherein at least one user of the predetermined group of users receives the information about the location by using a personal computer.

11. The method of claim 4, wherein at least one packet comprising information about the location replaces at least one speech or data packet.

12. The method of claim 4, wherein at least one packet comprising information about the location is transmitted among speech or data packets.

13. The method of claim 4, wherein each packet comprises information about whether it contains speech, data or information about the location of the mobile device.

14. The method of claim 1, wherein the information about the location of the mobile device is sent as a separate message.

15. The method of claim 7, further comprising:
detecting a pressing of a predetermined key of the mobile device,
activating speech transmission on the basis of the detection.

16. The method of claim 15, further comprising:
transmitting information about the location of the mobile device at the beginning of the transmission before speech or data.

17. The method of claim 15, further comprising:
transmitting information about the location of the mobile device in a predefined part of the transmission.

18. The method of claim 1, further comprising:
receiving a location query from the system, and
determining and transmitting information about the location of the mobile device in response to the query.

19. The method of claim 7, wherein
each device participating in the group call transmits information about its location to a predetermined participant in the group call, and
the predetermined participant in the group call transmits the information about the location of each device to all participants.

20. The method of claim 1, wherein the time when location was determined is included in the location information.

21. The method of claim 1, wherein the method with which the location was determined is included in the location information.

22. The method of claim 1, further comprising:
transmitting location information to a network server connected to the communication system, and
storing location information in the network server.

23. The method of claim 1, wherein the location information is sent without intervention by the user of the device.

24. The method of claim 1, wherein the information about the location of the mobile device is used as input information for an application running in a mobile device or a computer.

25. The method of claim 1, wherein predefined privacy levels assigned to predetermined groups or to users belonging to predetermined groups are taken into account in the transmission of information about the location of the mobile device.

26. The method of claim 1, wherein transmission of location related information is triggered by an external event detected by a sensor of the mobile device.

27. The method of claim 1, wherein transmission of location related information is triggered by a voice command or a sound.

28. A mobile device, comprising
determining means to determine the location of the mobile device, and
transmitting means connected to the determining means to transmit speech and/or data by using a predetermined transmission resource and to transmit information about the location of the mobile device by using the same predetermined transmission resource.

29. The mobile device of claim 28, further comprising means to establish a packet switched connection between the mobile device and a network element of a communication system as the predetermined transmission resource.

30. The mobile device of claim 28, further comprising means to determine the location of the mobile device using a satellite positioning system.

31. The mobile device of claim 28, further comprising means to determine the location of the mobile device using an inertia navigation arrangement.

32. The mobile device of claim 28, further comprising
a keyboard with at least one key,
means to detect a pressing of a predetermined key of the keyboard,
means to activate speech transmission on the basis of the detection.

33. The mobile device of claim 28, wherein the transmitting means are configured to transmit information about the location of the mobile device at the beginning of the transmission before speech or data.

34. The mobile device of claim 28, wherein the transmitting means are configured to transmit information about the location of the mobile device in a predefined part of the transmission.

35. A telecommunication system, comprising mobile devices and at least one network element, the system comprising
means to determine the location of a mobile device,
transmitting means in the mobile device to transmit speech and/or data to the network element by using a predetermined transmission resource, and to transmit information about the location of the mobile device by using the same predetermined transmission resources.

36. The system of claim 35, further comprising a network element configured to act as a group management server and at least two mobile devices configured to participate in a group call.

37. The system of claim 35, wherein the system comprises
mobile devices comprising a keyboard with at least one key, means to detect a pressing of a predetermined key of the keyboard, and means to signal a transmission request to the network element on the basis of the detection, wherein
the network element is configured to receive the request and allocate transmission turns between the mobile devices on the basis of the requests received from the mobile stations.

38. The system of claim 35, further comprising:
a network server configured to receive information about the location of the mobile device, and
a network server configured to store the information.

39. The system of claim 35, further comprising:
a network server configured to transmit location information relating to a mobile device to a group of other devices.

40. The system of claim 35, wherein
the time when the location was determined and the method with which the location was determined are included in the location information.

41. The system of claim 38, further comprising:
a network server configured
to receive a location information request,
to send location information updated within a given time limit as a response to the request,
and to request the updating of location information not updated within the given time limit.

42. A computer program product encoding a computer program of instructions for executing a computer process for data communication in a mobile device, the process comprising:
providing transmission and reception of speech and/or data by using a predetermined transmission resource,
determining the location of the mobile device of the communication system,
providing, with the speech or data, transmission of information about the location of the mobile device to a predetermined group of users by using the predetermined transmission resource.

43. A computer program distribution medium readable by a computer and encoding a computer program of instructions for executing a computer process for data communication in a mobile device, the process comprising:
providing transmission and reception of speech and/or data by using a predetermined transmission resource,
determining the location of the mobile device of the communication system,
providing, with the speech or data, transmission of information about the location of the mobile device to a predetermined group of users by using the predetermined transmission resource.

44. The computer program distribution medium of claim 43, the distribution medium comprising a computer readable medium, a program storage medium, a record medium, a computer readable memory, a computer readable software distribution package, a computer readable signal, a computer readable telecommunications signal, and a computer readable compressed software package.
